(19) United States
(12) Patent Application Publication
(10) Pub. No.: US 2006/0046948 A1
(43) Pub. Date: Mar. 2, 2006

(54) Chemical system for improved oil recovery

(75) Inventors: Yongchun Tang, Walnut, CA (US); Patrick Shuler, La Verne, CA (US); Yongfu Wu, Walnut, CA (US); Stefan Iglauer, Verl (DE)

Correspondence Address: DAVIS WRIGHT TREMAINE LLP, 865 FIGUEROA STREET, SUITE 2400, LOS ANGELES, CA, 90017-2566, US

(73) Assignee: California Institute of Technology, Pasadena, CA (US)

(21) Appl. No.: 11/215,061

(22) Filed: Aug. 30, 2005

Related U.S. Application Data
(60) Provisional application No. 60/605,440, filed on Aug. 30, 2004.

(51) Int. Cl. C11D 1/66

(52) U.S. Cl. 510/470

(57) ABSTRACT

The invention disclosed herein provides compositions and methods for mobilizing and extracting oil and other hydrocarbons present in subsurface reservoirs. Specifically, the invention relates to surfactant compositions comprising one or more alkyl polyglycosides (APGs) and one or more aromatic alcohols; methods of using such surfactant compositions; and products produced by these methods.

This application claims the benefit of priority from U.S. Provisional Application Ser. No. 60/605,440, filed Aug. 30, 2004.

### GOVERNMENT RIGHTS

The United States Government has certain rights in this invention pursuant to Grant No. DE-FC26-01BC15362, awarded by the U.S. Department of Energy.

### FIELD OF THE INVENTION

The invention relates to compositions and methods useful for extracting oil from subsurface reservoirs.

### BACKGROUND

Despite a finite supply, the worldwide demand for oil continues to grow. According to the Energy Information Administration, worldwide oil demand growth is expected to average about 1.8 million barrels per day between 2004 and 2006. In order to meet this demand, new methods for extracting and processing oil will be required.

Oil may be extracted from source rock in a number of stages. Generally, the first stage utilizes the pressure present in the underground reservoir to force the oil to the surface through a hole that is drilled from the surface down into the reservoir. This stage continues until the pressure inside the reservoir decreases such that it is insufficient to force oil to the surface, requiring additional oil extraction measures.

In the next stage, a number of techniques may be used to recover oil from reservoirs having depleted pressure. These techniques may include the use of pumps to bring the oil to the surface and increasing the reservoir's pressure by injecting water, steam, or gas. Injection of water into a well is often referred to as a “waterflood” and is used to increase oil recovery from an existing well.

However, after these methods have been applied, a large percentage of oil often remains trapped in porous rock. The injection of plain salt water alone, for example, may only recover half of the crude oil, with the remainder trapped as small oil droplets due to high capillary forces in the micron-size pores in the reservoir rock. As sources of oil continue to diminish, it will become increasingly desirable to find economically-viable ways to extract this trapped oil.

Surfactant enhanced oil recovery (EOR) is an approach useful for the mobilization and recovery of oil that is trapped in reservoir rock. EOR is based on the use of surfactants that reduce the interfacial tension (IFT) between the aqueous phase and the hydrocarbon phase, allowing for the mobilization of oil that is trapped in microscopic pores. A number of different surfactants have been investigated for their ability to mobilize oil that is trapped in rock. Alkyl polyglycosides (APGs) are a family of compounds that have emerged as useful for the mobilization of rock-trapped oil.

APGs were described initially over 100 years ago, first recognized as a potentially useful surfactant type in 1936, and then largely ignored until the 1980's. APGs have gained favor as economical processes were developed for their large-scale manufacture. There has also been an increased drive to use surfactants with favorable, low toxicity characteristics, and as a result, APGs are used in a number of in household detergents, cosmetics, and agricultural products (Balzer, D. (1991) Tenside Surf Det., 38:419-427). A recent estimate for worldwide capacity for APG surfactants is 80,000 tons/year (Hill, K. and Rhode, 0. (1999) Fett/Lipid, 10:25-33). APGs have been considered only briefly for EOR applications, with one U.S. patent issued on this topic (U.S. Pat. No. 4,985,154).

While the use of APGs are somewhat effective at mobilizing oil trapped in porous rock, the use of additional cosurfactants may significantly increase the usefulness of surfactant flooding. Based on the ever-increasing demand for oil, there is a significant need in the art for compositions and methods utilizing APGs along with cosurfactants to increase the recovery of oil from subsurface deposits.

### SUMMARY OF THE INVENTION

The invention described herein provides compositions and methods for mobilizing oil present in subsurface reservoirs. In some embodiments of the invention, an aqueous surfactant mixture comprising an amount of an alkyl polyglycoside and an amount of an aromatic alcohol are provided. Further embodiments provide for a surfactant mixture wherein the alkyl polyglycoside has the formula (I)
R—O—Zₙ
wherein R is a linear or branched, saturated or unsaturated C6-24 alkyl radical, and Zn is an (oligo)-glycosyl radical having n=1 to 10 hexose or pentose units or a mixture thereof.

Further embodiments include one or more aromatic alcohols selected from the group consisting of the alcohols of the aromatic compounds benzene, naphthalene, biphenyl, anthracene, phenanthrene, and combinations thereof. Related embodiments include one or more aromatic alcohols selected from the group consisting of phenol, 1-naphthol, 2-naphthol, 3-naphthol, and combinations thereof.

Still further embodiments provide for surfactant mixtures wherein R is a saturated or unsaturated C6-12 alkyl radical, and also provide for the weight ratio of alkyl polyglycoside to aromatic alcohol to be from about 1000:1 to about 1:1000, or from about 100:1 to about 1:100.

Additional embodiments include surfactant mixtures wherein the surfactant mixture further comprises between 0.1% and 30% salt, or between 1% and 10% salt.

Embodiments of the present invention include methods of mobilizing oil that is in contact with rock comprising contacting the oil with an aqueous surfactant solution containing an alkyl polyglycoside and an aromatic alcohol, and further comprises methods wherein the alkyl polyglycoside alkyl polyglycoside has the formula (I)
R—O—Zₙ
wherein R is a linear or branched, saturated or unsaturated C6-24 alkyl radical, and Zₙ is an (oligo)-glycosyl radical having n=1 to 10 hexose or pentose units or a mixture thereof.

Additional embodiments include methods wherein the aromatic alcohol is selected from the group consisting of the alcohols of the aromatic compounds benzene, naphthalene, biphenyl, anthracene, phenanthrene, and combinations thereof. Additional related embodiments include aromatic alcohols selected from the group consisting of phenol, 1-naphthol, 2-naphthol, 3-naphthol, and combinations thereof.

Other embodiments provide for methods wherein the R of the alkyl polyglycosides is a saturated or unsaturated C6-12 alkyl radical.

Still further embodiments provide for methods wherein the weight ratio of alkyl polyglycoside to aromatic alcohol is from about 1000:1 to about 1:1000, or from about 100:1 to about 1:100.

Other embodiments include methods wherein the aqueous surfactant solution further comprises between 0.1% and 30% salt, or between 1% and 10% salt (percent by weight).

Additional embodiments include methods wherein the aqueous surfactant solution is added to a system including oil and water in an amount sufficient to result in a final concentration of about 0.1 to 30% by weight, or a concentration of about 0.2 to 15% by weight.

Embodiments of the invention also provide for methods for the extraction of crude oil from an underground deposit that is penetrated by at least one injection well and at least one production well, comprising forcing a solution or a dispersion of a surfactant mixture containing an alkyl polyglycoside and an aromatic alcohol into an injection well.

In addition, the embodiments of the invention provide compositions comprising a quantity of extracted oil, produced by a process comprising providing a quantity of trapped oil; contacting the quantity of trapped oil with a quantity of aqueous surfactant solution containing an alkyl polyglycoside and an aromatic alcohol sufficient to mobilize the quantity of trapped oil; and recovering the mobilized oil.

The invention also provides embodiments that relate to methods of extracting hydrocarbons from a contaminated site comprising contacting the hydrocarbons with an aqueous solution comprising an alkyl polyglycoside and an aromatic alcohol.

### BRIEF DESCRIPTION OF THE DRAWINGS

FIG. 1 shows a schematic of the surfactant flood process as it may be applied to an oil field, in accordance with an embodiment of the present invention.

FIG. 2 depicts a typical alkyl polyglycoside (APG) structure, in accordance with an embodiment of the present invention.

FIG. 3 shows the IFT measured for equilibrated samples containing PG 2062 and smaller n-alcohols versus n-octane as the hydrocarbon phase, in accordance with an embodiment of the present invention.

FIG. 4 shows the influence of different APGs and n-alcohols on IFT, in accordance with an embodiment of the present invention.

FIG. 5 shows data illustrating IFT is nearly independent of temperature for a mixture of APG surfactant/alcohol versus n-octane as the hydrocarbon phase, in accordance with an embodiment of the present invention.

FIG. 6 shows data illustrating that IFT is nearly independent of the salinity for an APG surfactant/alcohol formulation versus n-octane as the hydrocarbon phase, in accordance with an embodiment of the present invention.

FIG. 7a shows the molecular structure of SPAN 20 surfactant, Sorbitan monolaurate, in accordance with certain embodiments of the present invention.

FIG. 7b shows the molecular structure of TWEEN 20 surfactant, Polyoxyethylene (20) Sorbitan monolaurate, in accordance with certain embodiments of the present invention.

FIG. 8 shows the IFT measured for equilibrated samples containing PG 2067 and selected SPAN Sorbitan surfactants, in accordance with certain embodiments of the present invention.

FIG. 9 shows that greater oil recovery occurs in a sand pack experiment when injecting a PG 2067/SPAN 20 chemical solution versus a waterflood, in accordance with an embodiment of the present invention.

FIG. 10 shows a comparison of IFT behavior for different alcohol cosurfactants, all containing 6 carbons, in accordance with an embodiment of the present invention.

FIG. 11 shows IFT data for aqueous salt solutions containing APG and 1-naphthol with n-octane as the hydrocarbon phase, in accordance with an embodiment of the present invention.

FIG. 12 shows that 1-naphthol as a cosurfactant with APG surfactants may create a low IFT condition at a low chemical concentration, in accordance with an embodiment of the present invention.

FIG. 13 shows the IFT response for both PG 2062 and the pure C16 version of APG surfactants formulated with 1-naphthol as a cosurfactant, in accordance with an embodiment of the present invention.

FIG. 14 shows the measured plateau adsorption of APG surfactants at a 20:1 ratio of solution:sand in an experiment carried out at 25° C., in accordance with an embodiment of the present invention.

FIG. 15 shows the calculated Hansen parameters for water, PG 2062, n-octane, and several alcohols, in accordance with an embodiment of the present invention. The IFT value associated with the alcohol as surfactant is given below its label (IFT for 0.8% PG 2062/1.2% n-alcohol, n-octane, 25° C.).

### DETAILED DESCRIPTION OF THE INVENTION

The invention disclosed herein relates to compositions and methods useful for the extraction of organic compounds from subsurface reservoirs. Specifically, it relates to the use of surfactant mixtures comprising amino polyglycosides (APGs) with aromatic alcohols. In one embodiment of the present invention, these compositions and methods may be used to mobilize and extract oil that is trapped in rock and/or other subsurface geological structures and materials.

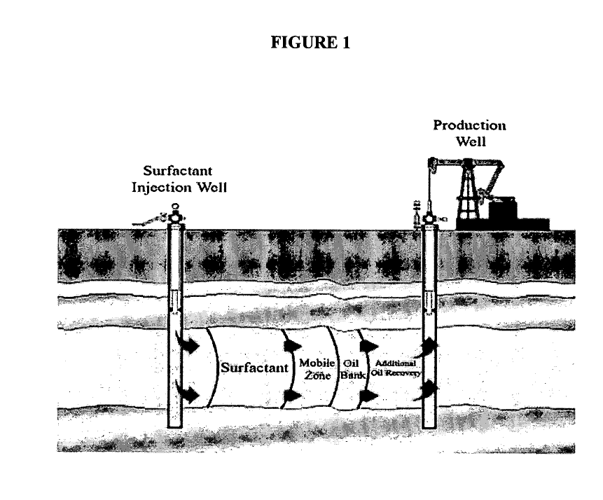

Some embodiments of the invention relate to the area of Improved Oil Recovery (IOR), a method that mobilizes oil located in subsurface reservoirs by a process called “surfactant flooding”. In surfactant flooding, an aqueous solution containing surfactants is injected into an oil reservoir in order to mobilize an amount of the crude oil trapped within the porous reservoir rock. Such surfactant formulations are formulated to reduce the interfacial tension (IFT) between the aqueous phase and the crude oil droplets and thereby move the oil within the micron-sized pore spaces in the reservoir rock that are held in place by high capillary forces. The mobilized oil may then be captured at a nearby production well. FIG. 1 shows a schematic of the surfactant flood process as it may be applied to an oil field.

Some aspects of the invention relate to the use of surfactants in EOR in a subsurface oil reservoir. A subsurface oil reservoir may be defined as an underground pool of liquid comprising hydrocarbons, sulfur, oxygen, and nitrogen trapped within a geological formation and protected from evaporation by the overlying mineral strata. The liquid may be also be trapped in porous rock.

Unless defined otherwise, technical and scientific terms used herein have the same meaning as commonly understood by one of ordinary skill in the art to which this invention belongs. One skilled in the art will recognize many methods and materials similar or equivalent to those described herein, which may be used in the practice of the present invention. Indeed, the present invention is in no way limited to the methods and materials described. In addition, all publications and patents cited herein are incorporated by reference.

Certain embodiments of the invention involve the use of alkyl polyglycoside (APG) compounds in conjunction with other co-surfactants to reduce the interfacial tension between the organic compounds such as petroleum trapped in rock, and the aqueous phase of a waterflood. The injected surfactant, which comprises APGs in conjunction with other cosurfactants, creates a decreased IFT that may aid in the mobilization of the oil remaining in pore spaces following a waterflood.

Oil, which is sometimes referred to as crude oil or petroleum, is a thick, dark brown or greenish flammable liquid, which exists in the upper strata of some areas of the Earth's crust. Oil is usually located 1,000-20,000 feet below the Earth's surface, and is often difficult to remove. The oil is often intermixed with the rock, resulting in high trapping forces and micron-sized drop sizes. It consists of a complex mixture of various hydrocarbons, largely of the alkane series, but may vary much in appearance, composition, and purity. As used herein, the term “oil” refers to any hydrocarbon substance. Alternatively, oils or hydrocarbons may be referred to as “organic compounds”. The term “hydrocarbon” refers to compounds comprising carbon and hydrogen. Organic compounds often contain other elements, including oxygen, sulfur and nitrogen, or halogens. An oil field is defined as the surface area overlying an oil reservoir or reservoirs. Commonly, the term includes not only the surface area but may include the reservoir, the wells, as well as production equipment.

A subsurface oil reservoir may be penetrated by one or more wells, which are perforations through the Earth's surface that contact the subsurface reservoir, or an area in proximity to a subsurface reservoir. The wells may be used to remove liquid and gas hydrocarbons from the subsurface reservoir, or to inject substances into the reservoir that aid in the extraction process. Examples of substances that may be injected include but are by no means limited to water, brine, steam, and surfactants. A production well is defined as a well from which oil is removed, and an injection well is defined as a well through which substances are injected into the reservoir to aid in the extraction of oil. When substances such as surfactants are injected into a well to aid in the extraction process, the volume of the substance injected is often referred to as a “slug”.

The term “surfactant” refers a compound that reduces the surface tension of a liquid. In cases where two liquids are present, such as an aqueous liquid and an organic liquid, a surfactant may decrease the surface tension between the two liquids. The term “surfactant mixture” as used herein, refers to a composition containing one or more compounds that reduce surface tension. When two non miscible liquids are present, each liquid may be referred to as a “phase”. In the case where one of the two liquids is oil, the oil phase may also be referred to as an “organic phase” or “hydrocarbon phase”.

The term “interfacial tension” (IFT) is related to surface tension, and may be defined as the tangential force at the surface between two liquids (or a liquid and a solid) caused by the difference in attraction between the molecules of each phase. Interfacial tension is generally expressed as a force per unit length or as an energy per unit area, for example, dynes per centimeter. Lower interfacial tension values generally indicate miscibility between two phases, and higher interfacial tension indicates non-miscibility. For example, the IFT between water and oil is usually 30-50 dynes/cm, and IFT between water and air (in this case, the same as the surface tension) is 72 dynes/cm. The goal of using surfactant based EOR is to drive the IFT closer to zero.

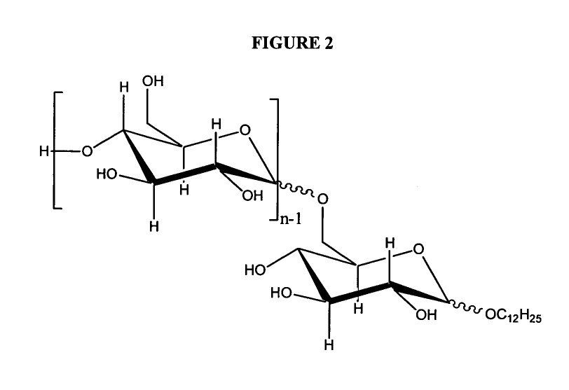

Alkyl polyglycosides (APG) are nonionic surfactants prepared with renewable raw materials, such as starch and fat or their components glucose and fatty alcohols. APGs generally comprise a hydrophobic moiety such as an alkyl group, and a hydrophilic portion derived from one or more carbohydrates, and are generally characterized by the formula
R—O—Zₙ
in which the variable R represents a linear or branched, saturated or unsaturated alkyl radical having 6 to 24 carbon atoms. The variable Zₙ represents an (oligo)glycosyl radical having on average, n=1 to 10 hexose or pentose units or mixtures thereof. A typical APG structure is shown in FIG. 2. The variable Zₙ represents an (oligo)glycosyl radical having, on average, n=1 to 10, and in some embodiments, 1.4 to 5 hexose or pentose units or mixtures thereof. Commercial APG products, such as those manufactured by Cognis Corporation generally comprise a mixture of molecular structures, both in terms of the number distribution of the head groups and the length of the alkyl groups in the hydrophobic tail.

The APG formulations have some interesting and useful properties as EOR agents. When mixed with a hydrophobic cosurfactant (e.g. an alcohol or some other surfactants), a middle-phase microemulsion may appear, that in some cases, create a low IFT (0.01 dyne/cm or less). An emulsion is a mixture of two immiscible substances wherein one substance is dispersed in the other. Previous work by others has shown phase behavior and IFT data of APG formulations in experiments with simple n-alkanes as the oil phase (Balzer, D. (1991) Tenside Surf Det., 38:419-427., Hill, K. and Rhode, O. (1999) Fett/Lipid, 10:25-33., Balzer, D. (1991) U.S. Pat. No. 4,985,154., Balzer, D., and Luders, H., editors.(1996) Nonionic Surfactants, Alkyl Polyglycosides, Marcel Dekker, New York, p. 228-243., Kutschmann, E. M., et. al. (1995) Colloid Polym. Sci. 273:565-571., Forster, T., et. al., (1996) Progr. Colloid Polym. Sci., 101:105-112, 1996).

The HLB (hydrophile-lipophile balance) of a surfactant refers to its behavior in creating emulsions and is related to its oil/water solubility. Higher HLB products, such as those found for these APG surfactants, indicate a higher degree of water solubility.

A useful property for APG formulations is that they are reported to have a phase behavior and IFT that is largely independent of temperature and salinity. This may be due to the fact that APGs are nonionic and generally have a large head group. Surfactant formulations that create a low IFT irrespective of temperature and salinity are useful for oilfield EOR applications that often involve broad ranges of temperature and salt concentration. As used herein, salinity is defined as the amount of salt dissolved in an aqueous solution. While sodium chloride is an example of a salt that is often abundant in EOR applications, the term “salt” generally refers to any ionic compound. Other salts that may be present in the solutions used in EOR applications include but are by no means limited to the salts of potassium, magnesium, and calcium. The term “brine”, as used herein, refers to an aqueous solution comprising salt.

In accordance with embodiments of the present invention, the range of salt concentration may from around 0.1% by weight (abbreviated hereafter as % wt) to around 30% wt. Further embodiments comprise salt concentrations between 1% wt and 15% wt. In terms of temperature, embodiments of the invention provide for temperatures from about 60° F. to about 250° F. Still further embodiments provide for processes occurring from about 75° F. to about 200° F.

Other reasons that APG surfactants are useful for extracting oil include that they are available already as commercial products and used already in significant quantities for other industrial applications, they are manufactured from renewable resources and so their cost is largely uncoupled from the current price of crude oil, and they are non-toxic. The use of APG surfactants for the extraction of crude oil from underground deposits is described in U.S. Pat. No. 4,985,154, which is incorporated herein by reference.

Aromatic alcohols may be added to APGs as cosurfactants in order to further decrease the IFT between an aqueous phase and oil in order to mobilize oil trapped in rock. Aromatic alcohols are defined as alcohols of organic compounds comprising one or more resonant, unsaturated rings of carbon atoms. Examples of aromatic compounds may be found in the text “Introduction to Organic Chemistry” (Streitwieser, A. and Heathcock, C., (1985) Macmillan Publishing Company, New York). Useful compounds include but are not limited to the alcohols of benzene, naphthalene, biphenyl, anthracene, phenanthrene as well as other multicyclic benzenoid hydrocarbons and their derivatives. Examples of aromatic alcohols include phenol, 1-naphthol, 2-naphthol, 3-naphthol, 1-hydroxydiphenyl, 2-hydroxydiphenyl, 3-hydroxydiphenyl, anthranol, and phenanthrenol. Additionally, aromatic alcohols with methyl or other substitutions are within the scope of the invention, and may be identified without undue experimentation by one of skill in the art.

It is possible that the aromatic alcohol may have limited solubility in aqueous surfactant solution, and the actual amount of compound dissolved may be less than the amount added to the formulation. In these cases, the amount of aromatic alcohol in solution may be estimated. It is also possible that additional co-solvents may be added to aid in the solubilization of the aromatic alcohols.

A target of an EOR process may be an oil deposit or reservoir that is penetrated by at least one injection well and one production well. A solution or a dispersion of a surfactant/co-solvent mixture may forced into the injection well. The surfactant mixture, which comprises at least one APG compound and at least one aromatic alcohol, may have a concentration of 0.1 to 30% wt, and in some embodiments, approximately 0.2 to 15% wt, and may be injected or dispersed in formation or flooding water. In other embodiments, the size of the slug of surfactant-containing liquid to be injected may be around 0.002 to 2 pore volumes. As used herein, the pore volume is defined as the total liquid-containing volume of the reservoir. Following injection of the slug of surfactant mixture, formation water or flooding water may be forced into the deposit, forcing the surfactant to move into the deposit. Liquids that are used to force the surfactant or other chemical into a deposit may be referred to as the “drive solution”. In order to maintain a favorable mobility ratio, it is possible to include a polymer in the surfactant formulation slug, or in the drive solution. The mobilized oil may then form a bank that may be driven to a nearby production well for recovery.

The salinity in the brine in the subsurface oil reservoir may vary both in an areal and vertical extent. Mature fields that have been subjected to years of waterflood (the primary targets for surfactant EOR) often have substantial differences in salinity, for example, due to contrasts between the injected and original formation brine.

An alternative embodiment in surfactant EOR is a “salinity-gradient” design whereby the salinity is reduced step-wise from the formation water, surfactant slug, and polymer/water drive. The motivation for this design is to generate a low IFT, middle-phase microemulsion condition in situ, with the following drive solutions designed to put the surfactant back into the aqueous phase in order to avoid excessive chemical loss by phase trapping.

In addition to being used to mobilize oil trapped in subsurface deposits, surfactant mixtures comprising an APG and an aromatic alcohol may be used to aid in the removal of hydrocarbons from sites on or close to the Earth's surface, such as a site of contamination. Examples include the use of surfactant mixtures to remove gasoline from the earth surrounding a gas station, or the use of surfactant mixtures to aid in the cleanup of an oil spill. Based on the beneficial effects of using APGs in combined with one or more aromatic alcohols, one of skill in the art would recognize that there are many potential useful applications of the invention in industrial, commercial, and residential settings.

### EXAMPLES

The following examples are provided to better illustrate the claimed invention and are not to be interpreted as limiting the scope of the invention. To the extent that specific materials are mentioned, it is merely for purposes of illustration and is not intended to limit the invention. One skilled in the art may develop equivalent means or reactants without the exercise of inventive capacity and without departing from the scope of the invention.

### Example 1

### The Influence of Alcohol Co-surfactants on the Interfacial Tensions of Alkylpolyglucoside Surfactant Formulations vs. n-Octane

In this study alkyl polyglycosides (APG) surfactants were formulated with various alcohols as co-surfactants in aqueous salt solutions with the objective of identifying combinations that attain low interfacial tensions (IFT) versus n-octane.

Three different commercial APG products supplied by Cognis Corporation were used (Table 1).

TABLE 1
Commercial APG Products Used in Study

| | Average | | | |
|---|---|---|---|---|
| Product | Alkyl Chain | Average n | HLB | Activity |
| PG 2067 | 9.1 | 1.7 | 13.6 | 70% |
| PG 2069 | 10.1 | 1.6 | 13.1 | 50% |
| PG 2062 | 12.5 | 1.6 | 11.6 | 50% |

The HLB (hydrophile-lipophile balance) of a surfactant refers to its behavior in creating emulsions and is related to its oil/water solubility. Higher HLB products, such as those found for these APG surfactants, indicate a higher degree of water solubility.

Several common alcohols were selected as co-solvents to create surfactant formulations with the APG surfactants. The alcohols were supplied by Aldrich. Most formulations included reagent grade sodium chloride, also supplied by Aldrich.

For the hydrocarbon phase, n-octane was used (Aldrich) as a model compound. Other studies have shown that IFT and phase behavior of crude oils often is represented well by n-alkanes ranging from n-hexane to n-decane. In this study, n-octane has been selected as a “typical” representative hydrocarbon. Surfactant formulations that are effective in reducing IFT versus n-octane may also be good candidates for mobilizing crude oils.

Test tube samples were prepared with 5 ml of aqueous surfactant/co-solvent/salt formulations and 5 mL of n-octane. After mixing for several hours, they were allowed to stand for a few weeks to allow the fluids to come to phase equilibrium at ambient conditions. The physical appearance of the phases was noted, such as the relative volumes of the aqueous and oleic phases, and if any third, middle-phase was formed. Other qualitative information collected is the color or opacity/clarity of the different liquid phases.

The interfacial tension (IFT) was determined for selected phase equilibrated test tube samples by using a spinning drop tensiometer (from Temco, Inc.) as detailed elsewhere (Cayais, J. L. et al., (1977), Surfactant Applications, Section 17). For our samples, we loaded the glass tube with the aqueous phase, followed by injection of a few micro-liters of the uppermost oleic phase. The glass tube was spun in the instrument and the IFT determined from the oil drop geometry. Because the samples already come from fluids at phase equilibrium, it usually required less than 2 hours for the measured IFT to stabilize to a final value.

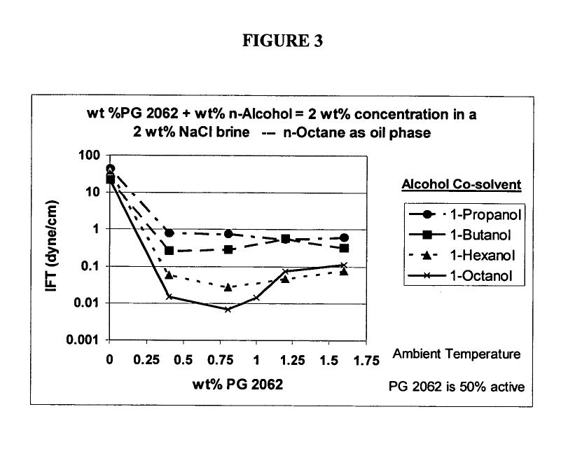

The alcohol co-solvents evaluated in this study included several n-alcohols ranging from C3 to C20. The aqueous phase has 2 wt % combined APG/Co-solvent concentration and has a default brine salinity of 2 wt % NaCl. The oil and aqueous surfactant solutions were mixed at a 1/1 volume ratio and equilibrated at ambient temperature. FIG. 3 shows IFT results with the PG 2062 APG surfactant and n-alcohols.

Note that the IFT for PG 2062 alone is about 2 dyne/cm, and for an alcohol alone, the IFT is over several dynes/cm, perhaps even greater than 30 dynes/cm. One explanation for the synergistic action of the added alcohols is that they pack at the interface so as to decrease the curvature of the interfacial layer and thereby reduce the IFT. These results suggests that an additive may work by linking the oil and surfactant molecules better at the interface.

The data suggest that n-octanol produce the lowest IFT condition (less than 0.01 dyne/cm.). Larger n-alcohols as co-solvents (not shown here) tended to produce a higher IFT. In addition, almost all of the samples shown in FIG. 3 had a third, middle-phase, if only a small volume. The IFT behavior versus the amount of APG and n-alcohol are fairly constant. This suggests that the low IFT condition may be attained with low concentrations of APG surfactant.

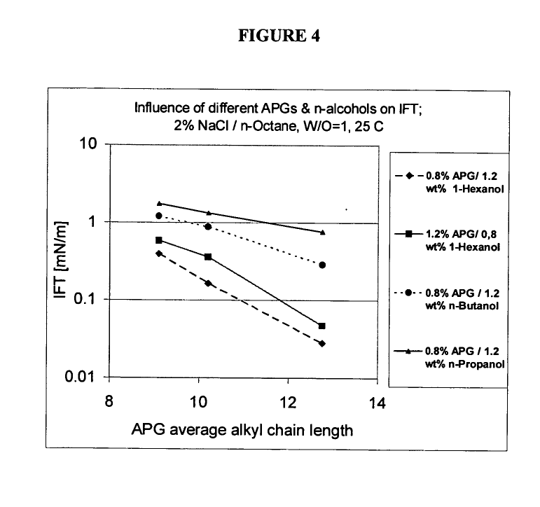

FIG. 4 summarizes data comparing the IFT measured among the 3 different commercial APG surfactants. The trend is that increasing the alkyl chain length of the APG surfactant decreases the IFT for the same APG/n-alcohol mixture.

The data in FIG. 4 indicate that the IFT for PG 2067 and PG 2069 (average alkyl chain lengths of 9.1 and 10.1, respectively) also have a lower IFT as the cosurfactant alcohol chain length increases from n-propanol to n-hexanol.

Other experiments examined the effect of other alcohols as co-solvents, focusing on the PG 2062 APG product, as it had the lowest IFT among the commercial APG products studied. Another series of tests examined a series of C6 alcohols as co-solvents, with the variation being the alcohol structure as a straight chain aliphatic, branched chain alcohol, saturated ring, and as an aromatic ring structure. Results show the straight chain (n-hexane) structure provides the lowest IFT among this group of co-solvents.

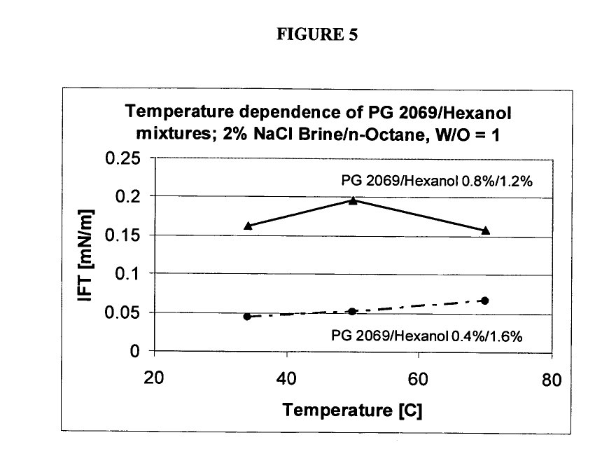

One important feature of these APG formulations is that the IFT appears to be largely independent of the temperature, as shown in FIG. 5. This is desirable because in oil reservoirs, the temperature will vary from zone to zone, with higher temperatures occurring in deeper subsurface depths. This behavior means that one may formulate a solution that is able to mobilize the crude oil in spite of these temperature differences.

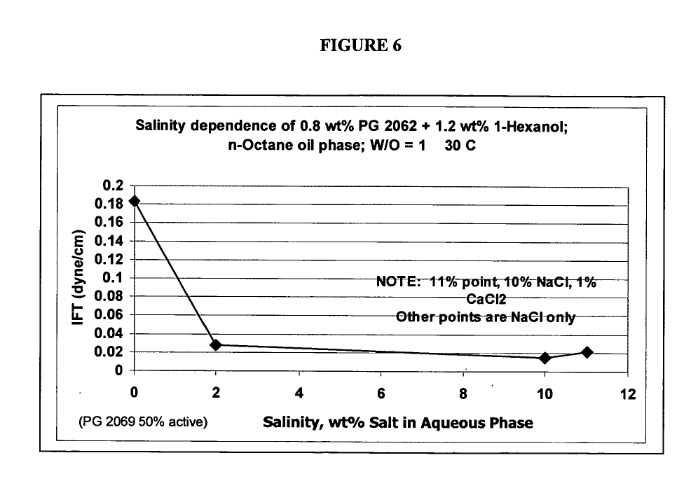

Similarly, the data confirm the reports in the literature that APG/alcohol formulations are also not very dependent on the salinity of the aqueous brine as shown in FIG. 6. This is also a desirable feature for application as an EOR chemical system. The salinity in the brine in the subsurface oil reservoir may vary from zone to zone. This property of the surfactant solution means that one may formulate a solution that is able to mobilize the crude oil in spite of the differences in the salinity.

This study demonstrates that alkyl polyglycoside (APG) surfactants, when mixed with some alcohols as co-solvent may be effective formulations for purposes of enhanced oil recovery (EOR). Attractive features of these formulations include: 1) low interfacial tension (IFT) may be obtained with low concentrations of APG surfactant, 2) these formulations may be remain at low IFT conditions in spite of changes that may occur with temperature and salinity.

### Example 2

### Synergistic Effect of Alkyl Polyglycoside and Sorbitan Mixtures on Lowering Interfacial Tension and Enhancing Oil Recovery

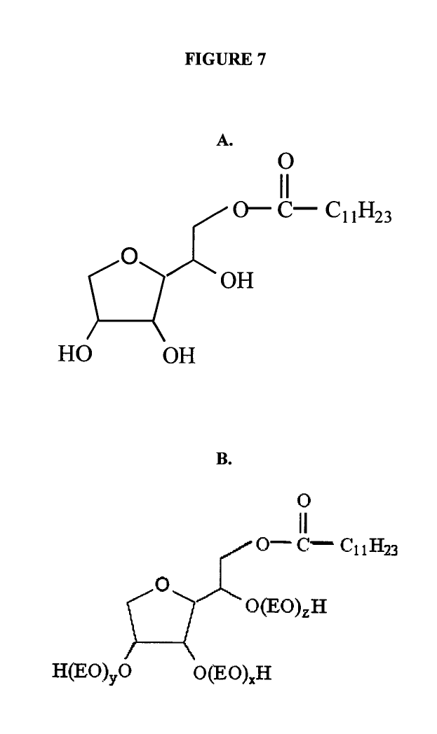

The structure shown in FIG. 7a is one of the common Sorbitan surfactants considered in this investigation. FIG. 7b shows variations of the TWEEN product line of surfactants.

In this study, alkyl polyglycosides (APG) surfactants were formulated with various Sorbitan surfactants in aqueous salt solutions, with the objective that this mixture has a low interfacial tension (IFT) versus n-octane. Such aqueous surfactant formulations may be potential EOR candidates.

We included three different commercial APG products supplied by Cognis Corporation in this study (see Table 1). The Sorbitan SPAN and TWEEN surfactants, shown in Table 2 and Table 3, were supplied by Aldrich.

TABLE 2
Sorbitan SPAN surfactants used in study.

| Product | Alkyl Chain | Average HLB |
|---|---|---|
| SPAN 20 | C12 | 8.6 |
| SPAN 40 | C16 | 6.7 |
| SPAN 60 | C18 | 4.7 |
| SPAN 80 | C18 (one double | 4.3 |
| | bond) | |
| SPAN 85 | 3 C18 (each has | 1.8 |
| | double bond) | |

TABLE 3
TWEEN surfactants used in study.

| Product | Number EO Groups | Average Alkyl Chain | HLB |
|---|---|---|---|
| TWEEN 20 | 20 | C12 | 16.7 |
| TWEEN 21 | 4 | C12 | 13.3 |
| TWEEN 40 | 20 | C16 | 15.6 |
| TWEEN 80 | 20 | C18 | 15.0 |
| TWEEN 81 | 5 | C18 | 10.0 |
| TWEEN 85 | 20 | 3 C18 chains | 11.0 |

The HLB (hydrophile-lipophile balance) of a surfactant refers to its behavior in creating emulsions and is related to its oil/water solubility. Higher HLB values indicate greater water solubility.

For the hydrocarbon phase, n-octane was used (Aldrich) as a model compound. Other studies have shown that IFT and phase behavior of crude oils often is represented well by n-alkanes ranging from n-hexane to n-decane. This study used n-octane as a “typical” representative hydrocarbon. Surfactant formulations that are effective in reducing IFT versus n-octane may also be good candidates for mobilizing crude oils.

Test tube samples were prepared with 5 ml of aqueous surfactant/cosurfactant salt formulations and 5 ml of n-octane. After mixing for several hours, they were allowed to stand for a few weeks to allow the fluids to come to phase equilibrium at ambient conditions. The physical appearance of the phases was noted, such as the relative volumes of the aqueous and oleic phases, and if any third, so-called middle-phase forms.

The interfacial tension (IFT) was determined for selected phase equilibrated test tube samples by using a spinning drop tensiometer (from Temco, Inc.) as detailed elsewhere (Cayais, J. L. et al., (1977), Surfactant Applications, Section 17). The samples were loaded into a glass tube with the aqueous phase, followed by injection of a few microliters of the uppermost oleic phase. The glass tube was spun in the tensiometer and the IFT determined from the oil drop shape. Because the samples already come from fluids at phase equilibrium, typically it required less than 2 hours for the measured IFT to stabilize to a final value.

This investigation also included oil displacement tests in porous media. Specifically, we injected APG/SPAN mixtures in salt water into sand packs comprising n-octane and measured the capability of such surfactant solutions to mobilize the hydrocarbon that could not be removed by flooding with a 2 wt % NaCl brine.

Sorbitan co-surfactants evaluated cover a spectrum of hydrophobic alkyl chain lengths, and in the case of the TWEEN products, a range of number of EO groups.

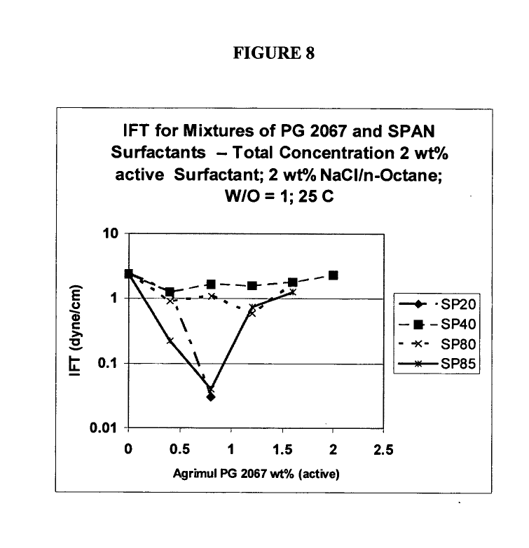

The aqueous phase has 2 wt % combined APG/Cosurfactant concentration and had a default brine salinity of 2 wt % NaCl. The oil and aqueous surfactant solutions were mixed at a 1:1 volume ratio and equilibrated at ambient temperature. FIG. 8 shows IFT results with the PG 2069 APG surfactant and SPAN surfactants.

Note that the IFT for PG 2067 alone and these SPAN products by themselves is about 2 dyne/cm. In some cases there is an obvious strong synergistic effect, with the IFT attaining very low values. One explanation for this synergistic action of the added surfactants is that they pack at the interface so as to decrease the curvature of the interfacial layer and thereby reduce the IFT. That is, the second surfactant may improve performance by linking the oil and surfactant molecules better at the interface.

It was observed that the two “end members” of the SPAN series, SPAN 20 (HLB=8.6) and the SPAN 85 (HLB=1.8) can create a low IFT when used in these APG formulations. Also, preliminary data suggest that a low IFT may occur with PG 2067/SPAN 60 mixtures (data not shown).

Table 4 lists a sample of the IFT results for different combinations of the longer alkyl chain APG products, PG 2069 and PG 2062, and various SPAN products.

TABLE 4
Measured IFT for APG/SPAN surfactant mixtures in 2% NaCl versus n-
octane as the hydrocarbon phase.

| | | | | |
|---|---|---|---|---|
| | SPAN | weight | weight | IFT |
| APG | Product | % APG | % SPAN | (dyne/cm) |

| | | | | |
|---|---|---|---|---|
| PG 2069 | 20 | 0.80 | 1.20 | 0.0035 |
| PG 2069 | 40 | 0.40 | 1.60 | 1.40 |
| PG 2069 | 60 | 0.40 | 1.60 | 0.33 |
| PG 2069 | 85 | 0.40 | 1.60 | 1.55 |
| PG 2069 | 85 | 1.50 | 0.50 | 0.8 |
| PG 2069 | 85 | 1.60 | 0.40 | 1.2 |
| PG 2062 | 20 | 0.80 | 1.20 | 0.90 |
| PG 2069 | 20 | 1.20 | 0.80 | 0.75 |
| PG 2069 | 40 | 0.40 | 1.60 | 0.85 |
| PG 2069 | 60 | 0.40 | 1.60 | 1.00 |
| PG 2069 | 60 | 0.80 | 1.20 | 0.73 |
| PG 2069 | 80 | 0.40 | 1.60 | 1.20 |
| PG 2069 | 85 | 0.40 | 1.60 | 0.68 |
| PG 2069 | 85 | 0.80 | 1.20 | 0.25 |
| PG 2069 | 85 | 1.20 | 0.80 | 0.40 |

In the combinations (shown above) where all of the phase (aqueous, microemulsion, and oleic) appear to be fluid, the measured IFT results cover a sizable range of values. The IFT value is especially low (0.0035 dyne/cm) for the first sample shown (the PG 2069/SPAN 20 blend at 0.8/1.2 wt %), but the IFT exceeds 0.1 dyne/cm for all of the others in Table 5.

TABLE 5
Measured IFT for APG/TWEEN surfactant mixtures in 2% NaCl versus
n-octane hydrocarbon phase.

| | TWEEN | | | IFT |
|---|---|---|---|---|
| APG | Product | % APG | % TWEEN | (dyne/cm) |
| PG67 | 21 | 1.20 | 0.80 | 1.07 |
| PG67 | 21 | 1.60 | 0.40 | 1.42 |
| PG67 | 85 | 0.80 | 1.20 | 0.76 |
| PG67 | 85 | 1.00 | 1.00 | 0.38 |
| PG67 | 85 | 1.20 | 0.80 | 0.9 |
| PG67 | 85 | 1.60 | 0.40 | 0.82 |
| PG69 | 21 | 1.60 | 0.40 | 1.25 |
| PG69 | 40 | 1.60 | 0.40 | 1.7 |
| PG69 | 81 | 1.00 | 1.00 | 9.6 |
| PG62 | 21 | 0.40 | 1.60 | 0.05 |
| PG62 | 81 | 0.40 | 1.60 | 1.3 |
| PG62 | 81 | 0.80 | 1.20 | 6.10 |
| PG62 | 85 | 0.40 | 1.60 | 0.76 |

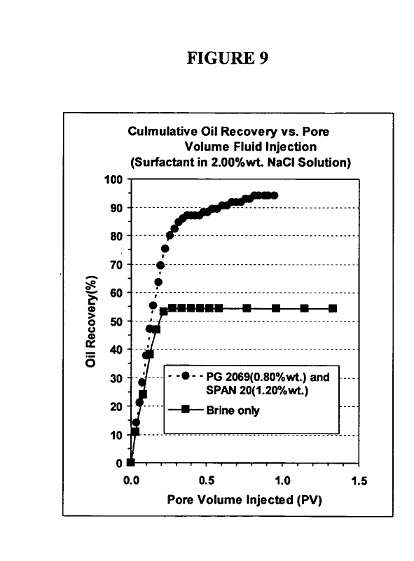

FIG. 9 shows there is, as expected, a large increase in oil recovery in the laboratory experiment with the PG 2069/SPAN 20, 0.8/1.2 wt % formulation (measured IFT reported in Table 3 is 0.003 dyne/cm). While in some cases 55% of the n-octane (oil) was mobilized by brine, the surfactant formulation displaced almost all oil.

This study demonstrated that alkyl polyglycosides (APG) and sorbitan-based surfactants may be combined to create chemical formulations useful for purposes of enhanced oil recovery (EOR).

### Example 3

### The Influence of Alcohol Co-surfactants on the Interfacial Tensions of Alkylpolyglucoside Surfactant Formulations with Aromatic Alcohols

Aromatic alcohols were investigated for their potential to reduce the IFT between aqueous and hydrocarbon phases when included as a cosurfactant with APGs. Additional studies were carried out with 1-naphthol as the cosurfactant. It was found that 1 -naphthol, when added to an APG surfactant, created a low IFT, even at very low APG concentrations.

Experiment 1

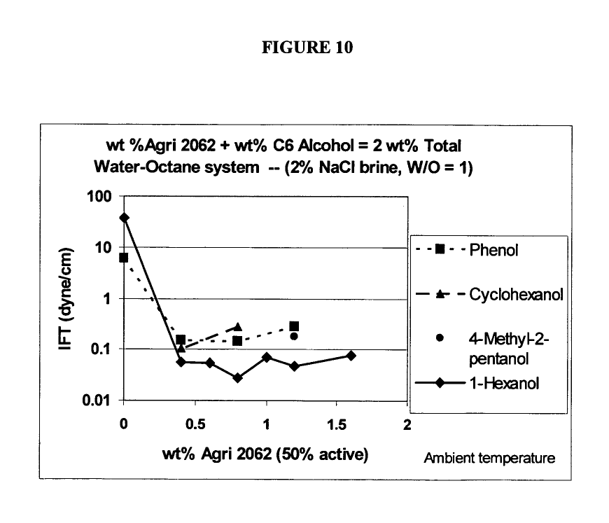

This series included the PG 2062 commercial APG surfactant and a series of alcohol cosurfactants, with each alcohol cosurfactant having with 6 carbons. The hydrocarbon phase was n-octane. The data in FIG. 10 show that the IFT was roughly similar for the 4 different cosurfactants tested, but the 1-alcohol structure had a lower IFT versus the branched, ring, and aromatic versions. Agrimul PG 2062 is a commercial APG surfactant from Cognis Corp. The weight percent of PG 2062 plus cosurfactant is 2%, in a 2% NaCl brine, and there were equal volumes of aqueous phase and organic phase. All of the additives used had six carbons.

The IFT for the PG 2062 surfactant by itself had a relatively high value of about 2 dyne/cm. It was observed that the IFT values are much lower not only for the aliphatic alcohols like n-hexanol and 4-methyl-2-pentanol, but also for the aromatic alcohol phenol. Adding cyclohexanol to APG also decreased the IFT.

Experiment 2

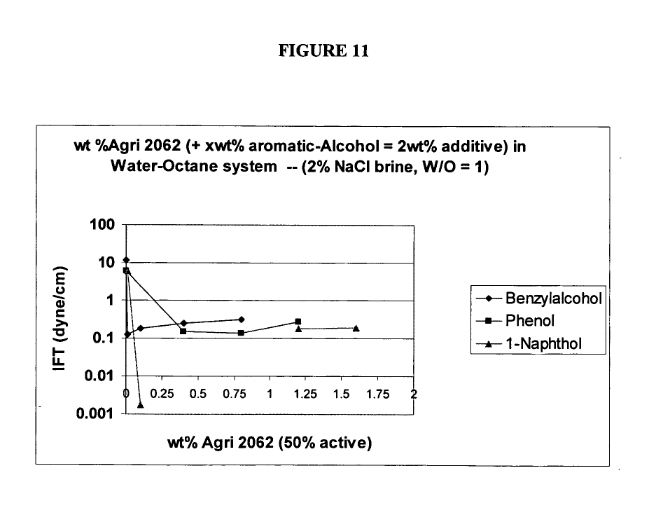

Further experiments were carried out to observe the how different aromatic alcohols, including benzyl alcohol, phenol, and 1-naphthol affect the IFT when included as co-surfactants with an APG. FIG. 11 shows that most of the IFT values are around 0.2 dyne/cm.

One exception was the low IFT of 0.002 dyne/cm found with the very low concentration of 0.1 wt % PG 2062 (only 0.05 wt % on an active basis) and a greater concentration of 1-naphthol. (While FIG. 11 indicates the 1-napthol concentration is close to 2 wt %, actually the dissolved concentration is much less due its limited solubility of this solid compound in water.).

Experiment 3

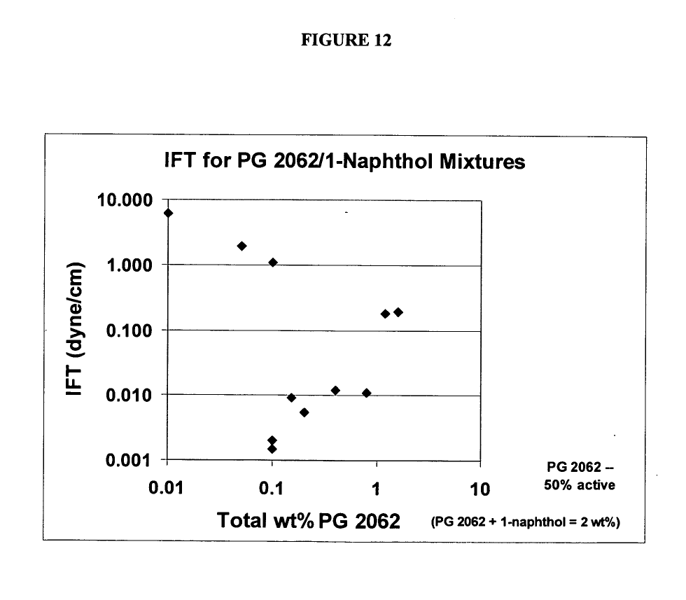

In further experiments, the IFT was measured using 1-naphthol as a cosurfactant with an APG. FIG. 12 shows IFT data between aqueous salt solutions having APG and 1-naphthol as the cosurfactant in experiments that used n-octane as the hydrocarbon phase. The experiment was done at ambient temperature with a 1:1 volume ratio of aqueous phase to organic phase. The aqueous phase contained 2% wt NaCl, and the organic phase was n-octane.

The IFT of the solutions shown in FIG. 12 approached 0.001 dyne/cm. The added concentration for the 1-naphthol is 1.9 wt %, but the actual dissolved concentration is much less due to its limited solubility. From other tests we estimated the actual dissolved concentration of 1-naphthol in the water and oil to be roughly between 100-1000 ppm.

Experiment 4

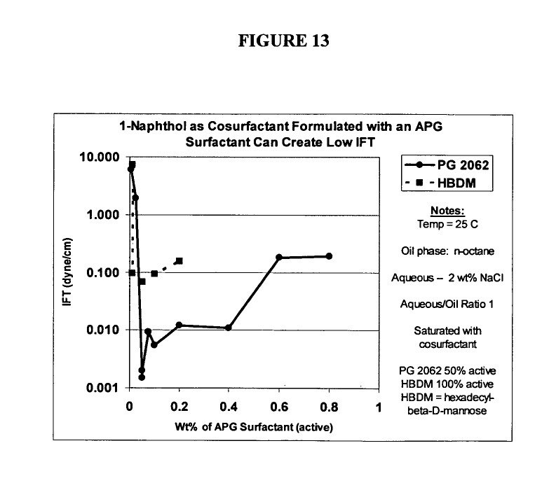

FIG. 13 compares the IFT response for both PG 2062 and the pure C16 version of (HBDM, Hexadecyl-beta-D-mannose) APG surfactants when formulated with 1-naphthol as a cosurfactant. The precise dissolved concentration of the cosurfactant in each sample was unknown, as 1-naphthol has limited solubility in water and hydrocarbon (n-octane used here as the oil phase), and was added in excess. Tests with a gas chromatography analysis of the equilibrated fluids determined the actual dissolved concentration of 1-naphthol to be several hundred ppm in the aqueous phase, and perhaps as high as a few thousand ppm in the n-octane hydrocarbon phase.

Follow-up studies included tests where the solid 1-naphthol was “packaged” different ways. First, there was a series of tests where the added 1-naphthol concentration is only several ppm (5-10 ppm) and the initial aqueous solution had PG 2062 concentrations ranging from 0.1-1.5 wt % in a 2 wt % NaCl brine. The measured IFT versus n-octane ranged from 0.4-0.7 dyne/cm at 25 C; the PG 2062 surfactant solutions versus n-octane created IFT values of more than 2 dyne/cm; the IFT became less than 1 dyne/cm just with very low ppm concentration additions of the 1-napthol.

Experiment 5

The next test series used a fresh, water-saturated 1-naphthol solution as the to create several APG/1-naphthol formulations. Because the 1-naphthol solubility in fresh water is several hundred ppm at ambient temperature, these aqueous formulations have a concentration of this cosurfactant that is about 100 times greater than the previous set of samples. The IFT values were about the same for these samples as the previous series with the very dilute 1-naphthol concentrations. Table 6 shows the IFT values for PG 2062/1-naphthol formulations versus n-octane, with the initial values of 1-naphthol of about 600 ppm in the aqueous phase.

TABLE 6
IFT values for PG 2062/1-naphthol formulations with n-octane as the
hydrocarbon phase

| PG 2062 Concentration (wt %) | Measured IFT (dyne/cm) |
|---|---|
| 0.5 | 0.46 |
| 0.75 | 0.39 |
| 1 | 0.42 |
| 1.5 | 0.4 |
| 1.75 | 0.33 |

Notes:
n-Octane as oil phase, W/O = 1, Brine of 2 wt % NaCl, Room Temperature Estimated starting concentration of added 1-naphthol is 600 ppm in the aqueous phase.

Experiment 6

The next test series utilized the 1-naphthol at higher concentrations in the aqueous formulation; this is accomplished by first dissolving the 1-naphthol in a mutual solvent where it has very high solubility. Table 7 shows IFT results where the stock solution for adding the l-naphthol is via a 90/10 by weight blend of ethanol/1-naphthol, and also shows the IFT for PG 2062/ethanol/1-naphthol formulations n-octane as the hydrocarbon phase.

TABLE 7
IFT for PG 2062/ethanol/1-naphthol formulations versus n-octane.

| | Ethanol/1- | | |
|---|---|---|---|
| | naphthol Mixture | 1-naphthol | |
| PG 2062 | Concentration | Concentration | Measured IFT |
| Concentration | (wt %) | (wt %) | (dyne/cm) |
| 0.1 | 1.7 | 0.17 | 0.12 |
| 0.25 | 1.6 | 0.16 | 0.16 |
| 0.5 | 1.4 | 0.14 | 0.30 |
| 0.75 | 1.1 | 0.11 | 0.30 |
| 1.0 | 0.9 | 0.09 | 0.35 |
| 1.5 | 0.5 | 0.05 | 0.48 |

Notes:
n-Octane is oil phase, W/O = 1, Brine is 2 wt % NaCl, Room Temperature

These results shown in Table 7 indicate that the IFT decreases with lower concentrations of PG 2062 (and where the ratio of 1-napthol/PG2062 is greater).

Experiment 7

The next series of phase behavior/IFT tests including 1-naphthol as a cosurfactant considered other alcohols as a carrier for the 1-napthol. The results are shown in Table 8.

TABLE 8
IFT for PG 2062/alcohol/1-naphthol formulations versus n-octane.

| Alcohol | | | |
|---|---|---|---|
| Concentration | Alcohol | 1-naphthol | Measured IFT |
| (wt %) | Diluent | Concentration (wt %) | (dyne/cm) |
| 1.5 | ethanol | 0.5 | 0.017 |
| 1.5 | 1-propoanol | 0.5 | 0.015 |
| 1.5 | cyclohexanol | 0.5 | 0.82 |
| 1.5 | 1-butanol | 0.5 | 0.005 |

Notes:
PG 2062 is 0.1 wt % (0.05 wt % active);
n-Octane as oil phase, W/O = 1, Brine of 2 wt % NaCl, Room Temperature

These data suggest that aromatic alcohols, such as phenol and 1-naphthol may act as effective co-surfactants for removing oil.

### Example 4

### Coreflood Experiment to Measure Displacement of Residual Oil

One method to measure the amount of residual oil displaced with a surfactant is to use a coreflood. Common laboratory procedures were used to test mobilization of residual oil from Berea sandstone cores. A coreflood test may comprise the following steps: 1) saturation of a Berea sandstone core (1″×12″) with a brine, 2) pump brine through the core to condition it to the water chemistry and establish the initial permeability by measurement of rate and pressures, 3) displace the brine with the test oil (an n-alkane) until reaching an irreducible water condition 4) water flood with a brine until reach residual oil saturation. 5) inject the candidate surfactant formulation for a target pore volume, and 6) inject the polymer chaser slug/water drive until obtain no further tertiary oil recovery.

The flow experiments may be performed at a nominal superficial velocity of about 3 feet/day during the chemical injection steps. Higher velocities may be used during the flow stapes to introduce brine and oil.

A coreflood experiment was performed to determine how well a very low APG concentration formulation using 1-naphthol as a cosurfactant could displace residual oil. Based on the low IFT value shown in Table 8, an APG formulation with a 1-butanol/1-naphthol mixture was used. The tertiary oil recovery was about 40%.

The coreflood used a 1″×12″ Berea sandstone core that had approximately 300 md water permeability. The oil, or hydrocarbon phase was n-octane, and the waterflood residual oil saturation was 0.31. The Connate brine composition was 2 wt % NaCl. The PG 2062 was formulated in 2 wt % NaCl comprised the following: 0.1 wt % PG 2062 surfactant (0.05% on an active basis), 2 wt % in-butanol/1-naphthol mixture in a weight ratio of 75/25 n-butanol/1-naphthol, and a 0.8 Pore Volume slug.

The drive polymer solution comprised the following: 350 ppm Alcoflood 1235 (Ciba Corp.) in 2 wt % NaCl, 2 Pore Volume. The drive polymer solution was used to force the surfactant into the core.

Chemical injection occurred at 0.05 ml/min, or about a 3 ft/Day frontal advance rate. With only 0.05 wt % (active) of the APG surfactant (PG 2062) in the injected chemical slug, there was significant tertiary oil recovery of about 40%.

### Example 5

### Surfactant Solid Adsorption

APG surfactant adsorption from 2 wt % NaCl brines was measured onto kaolinite clay. All of these tests were conducted at 25° C. with a weight ratio of liquid/solid of 20, and for a mixing exposure period of 8 hours. Kaolinite was selected (obtained from the University of Missouri) as the adsorbent of choice because 1) it is among the most common clays found in oil reservoirs, 2) it may be obtained in a fairly reproducible form, and 3) it is a stable material (e.g., will not swell when immersed in water).

The composition provided by the supplier for the kaolinite has the following major components (weight percents):
SiO₂ 44.2, Al₂O₃ 39.7, TiO₂ 1.39, Fe₂O₃ 0.13
   with trace amounts of sodium, manganese, calcium, potassium, phosphorous, and fluorine. The specific surface area is about 10 square meter/gram.

After the 8-hour exposure period, the sample was centrifuged and the supernatant analyzed for residual surfactant concentration via a gravimetric method. Knowing the activity of the starting surfactant material and brine salinity, the mass of surfactant that is left in the supernatant solution after evaporating off the water solvent can be calculated.

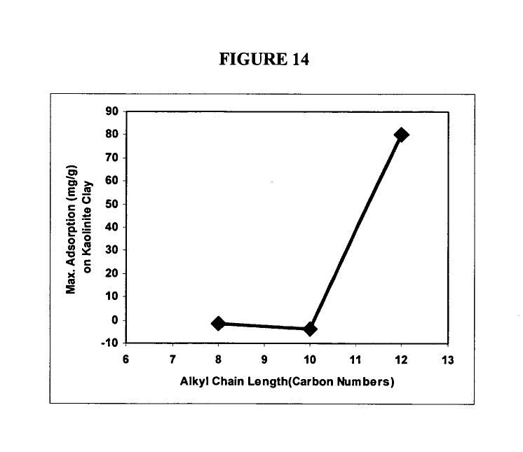

Maximum adsorption measured for the 3 commercial APG surfactants (PG 2067, PG 2069, and PG 2062) are shown, left to right in FIG. 14. Other surfactant retention tests onto kaolinite clay were performed with APG mixed with alcohol and a SPAN product (Table 9). Tests were in 2 wt % NaCl and a ratio of solution/solid of 20:1.

TABLE 9
Selected adsorption results for APG/cosurfactant formulations

| | Surfactant(s) | |
|---|---|---|
| | (mg surfactant/gm | IFT |
| Surfactant(s) | kaolinite) | (dyne/cm)** |
| PG 2067 0.5% | negligible | 2 |
| PG 2059 0.5% | negligible | 2 |
| PG 2062 0.5% | 61 | 2 |
| SPAN 20 0.5% | 82 | 2 |
| PG 2067 0.4% SPAN 20 0.6% | 87 | 0.04 |
| PG 2069 0.4% SPAN 20 0.6% | 121 | 0.0035 |
| PG 2062 0.4% SPAN 20 0.6% | 132 | 1.5 |
| PG 2062 0.4% 1-propanol 1.2% | 41 | 0.8 |
| PG 2062 0.4% 1-butanol 1.2% | 42 | 0.3 |
| PG 2062 0.4% 1-hexanol 1.2% | 52 | 0.03 |
| PG 2062 0.4% 1-octanol 1.2% | 46 | 0.007 |

**IFT measured in separate experiment. IFT for surfactant formulation made up in a 2 wt % NaCl brine after phase equilibration reached with n-octane at 25° C.

The data suggest that low adsorption for APG product with shorter alkyl chains, but significant adsorption for the PG 2062, and the total surfactant adsorption increased when mixing with the SPAN 20 sorbitan surfactant. Also, the adsorption levels with mixtures of PG 2062 and 1-alcohols were almost independent of the specific alcohol cosurfactant selected.

The anticipated surfactant adsorption in a sandstone rock would be less (estimate by an order of magnitude) because the clay content would be only a few percent in a typical reservoir. Roughly speaking, adsorption levels of 10 mg/gram kaolinite (perhaps 0.1-1 mg/gram sandstone) are typical for alkyl aryl sulfonate surfactants used for EOR. This suggests the adsorption of the PG 2062 may be greater than that for common EOR surfactants, but that the PG 2067 and PG 2069 adsorption levels are much less.

### Example 6

### Calculation of Hansen Parameters for Several Compounds

Hansen parameters for several compounds were calculated. Recent work at the California Institute of Technology have developed molecular modeling approaches to calculate Hansen parameters (Belmares, M. et al., (2004) Journal of Computational Chemistry 25:1814-1826). A Cohesive Energy Density (CED) computational method was used that offers consistency (precision) throughout the various organic compounds of interest in formulation work. CED is a multiple sampling Molecular Dynamics (MD) method that estimates Hildebrand and Hansen solubility parameters with good precision (ca. 0.44 hildebrands). The CED method, when combined with a generic force field and quantum mechanically determined atomic charges yields first-principles Hildebrand parameter predictions in good agreement with experiment (accuracy is 1. Hildebrand or better).

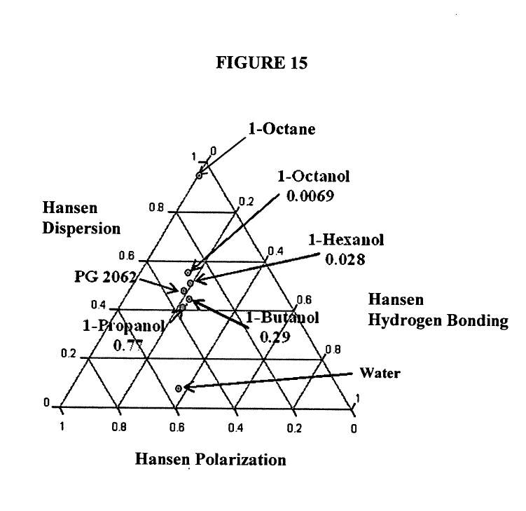

The three Hansen parameters for some of the components of the APG/alcohol formulations were compared. FIG. 15 is a plot of normalized values for the three Hansen parameters for several pure substances. These values for the PG 2062 APG surfactant, water, n-octane, and several alcohol cosurfactants are calculated as described earlier.

The plots have a notation about the measured IFT value underneath each alcohol. This IFT is for a PG 2062 (0.8%) and alcohol cosurfactant (1.2%) formulation in a 2 wt % NaCl brine versus n-octane at room temperature.

From the observed pattern of component Hansen parameters associated with a low IFT, one may gain guidance with respect to producing new formulations for low IFT. A future approach would be to calculate the Hansen parameters for a number of new compounds, and focus on those with follow-up experimental studies that exhibit the observed successful pattern of Hansen values.

For these results, it was found that the IFT is lower for PG 2062/alcohol formulations when the alcohol Hansen dispersion parameter increases, polarization parameter decreases, and hydrogen bonding parameter decreases. As the Hansen parameters for this alcohol series become more similar to the values for n-octane, the model oil phase, the PG 2062/alcohol formulation may reduce the interfacial tension to its lowest measured values in this study.

While the description above refers to particular embodiments of the present invention, it should be readily apparent to people of ordinary skill in the art that a number of modifications may be made without departing from the spirit thereof. The accompanying claims are intended to cover such modifications as would fall within the true spirit and scope of the invention. The presently disclosed embodiments are, therefore, to be considered in all respects as illustrative and not restrictive, the scope of the invention being indicated by the appended claims rather than the foregoing description. All changes that come within the meaning of and range of equivalency of the claims are intended to be embraced therein.

What is claimed is:

1. An aqueous surfactant mixture, comprising:
an amount of an alkyl polyglycoside; and
an amount of an aromatic alcohol.

2. The surfactant mixture of claim 1, wherein the alkyl polyglycoside has the formula
R—O—Zₙ
wherein R is a linear or branched, saturated or unsaturated C6-24 alkyl radical, and Zₙ is an (oligo)-glycosyl radical having n=1 to 10 hexose or pentose units or a mixture thereof.

3. The surfactant mixture of claim 1, wherein the aromatic alcohol is selected the group consisting of the alcohols of the aromatic compounds benzene, naphthalene, biphenyl, anthracene, phenanthrene, and combinations thereof.

4. The surfactant mixture of claim 1, wherein the aromatic alcohol is selected from the group consisting of phenol, 1-naphthol, 2-naphthol, 3-naphthol, and combinations thereof.

5. The surfactant mixture of claim 2, wherein R is a saturated or unsaturated C6-12 alkyl radical.

6. The surfactant mixture of claim 1, wherein the weight ratio of alkyl polyglycoside to aromatic alcohol is from about 1000:1 to about 1:1000.

7. The surfactant mixture of claim 1, wherein the weight ratio of alkyl polyglycoside to aromatic alcohol is from about 100:1 to about 1:100.

8. The surfactant mixture of claim 1, wherein the surfactant mixture further comprises a salt at a concentration of about 0.1 to about 30% by weight.

9. The surfactant mixture of claim 1, wherein the surfactant mixture further comprises a salt at a concentration of about 1 to about 10% by weight.

10. A method of mobilizing oil and/or hydrocarbons in contact with rock, comprising:
providing an aqueous surfactant solution comprising an alkyl polyglycoside and an aromatic alcohol; and
contacting the oil and/or hydrocarbons with the aqueous surfactant solution.

11. The method of claim 10, wherein the alkyl polyglycoside has the formula
R—O—Zₙ
wherein R is a linear or branched, saturated or unsaturated C6-24 alkyl radical, and Zₙ is an (oligo)-glycosyl radical having n-1 to 10 hexose or pentose units or a mixture thereof.

12. The method of claim 10, wherein the aromatic alcohol is selected from group consisting of the alcohols of the aromatic compounds benzene, naphthalene, biphenyl, anthracene, phenanthrene, and combinations thereof.

13. The method of claim 10, wherein the aromatic alcohol is selected from the group consisting of phenol, 1-naphthol, 2-naphthol, 3-naphthol, and combinations thereof.

14. The method of claim 11, wherein R is a saturated or unsaturated C6-12 alkyl radical.

15. The method of claim 10, wherein the weight ratio of alkyl polyglycoside to aromatic alcohol is from about 1000:1 to about 1:1000.

16. The method of claim 10, wherein the weight ratio of alkyl polyglycoside to aromatic alcohol is from about 100:1 to about 1:100.

17. The method of claim 10, wherein the aqueous surfactant solution further comprises a salt at a concentration of about 0.1 to about 30% by weight.

18. The method of claim 10, wherein the aqueous surfactant solution further comprises a salt at a concentration of about 1 to about 10% by weight.

19. The method of claim 10, wherein contacting the oil and/or hydrocarbons further comprises adding the aqueous surfactant solution to a system including oil and/or hydrocarbons and water in an amount sufficient to result in a final concentration of the aqueous surfactant solution of about 0.1% to about 30% by weight.

20. The method of claim 10, wherein contacting the oil and/or hydrocarbons further comprises adding the aqueous surfactant solution to a system including oil and/or hydrocarbons and water in an amount sufficient to result in a final concentration of the aqueous surfactant solution of about 0.2% to about 15% by weight.

21. A method of extracting crude oil from an underground deposit that is penetrated by at least one injection well and at least one production well, comprising:
providing a surfactant mixture comprising an alkyl polyglycoside and an aromatic alcohol; and
forcing a solution or a dispersion of the surfactant mixture into said injection well,
whereby crude oil is extracted through the production well.

22. A composition comprising a quantity of oil, produced by a process comprising:
providing an aqueous surfactant solution comprising an alkyl polyglycoside and an aromatic alcohol;
contacting a quantity of trapped oil with a quantity of the aqueous surfactant solution sufficient to mobilize at least a portion of the quantity of trapped oil; and
recovering at least a portion of the mobilized oil.
